(19) United States
(12) Patent Application Publication
(10) Pub. No.: US 2025/0355955 A1
(43) Pub. Date: Nov. 20, 2025

(54) MULTI-INTENT QUERY RESULT RETRIEVAL

(71) Applicant: Walmart Apollo, LLC, Bentonville, AR (US)

(72) Inventors: Neeraj Sharma, Irving, TX (US); Venkata Phani Kumar Boggavarapu, San Ramon, CA (US); Yogananda Domlur Seetharama, Mississauga (CA); Jonathan Fox, Rogers, AR (US); Grandhe Tejendher Venkata Akhilesh, Andhra Pradesh (IN)

(21) Appl. No.: 18/664,607

(22) Filed: May 15, 2024

(51) Int. Cl. G06F 16/9538; G06F 16/9535

(52) U.S. Cl. CPC G06F 16/9538; G06F 16/9535

(57) ABSTRACT

Examples provide a query intent-aware search retrieval system using generative artificial intelligence (AI) and vector similarity search. A customized profanity filter performs a customized profanity check to maintain search retrieval system integrity and prevent misuse by malicious actors. This safeguard ensures that inappropriate or offensive language is effectively detected and mitigated, contributing to a secure and user-friendly experience. A customized prompt generator provides pertinent recall queries for a specific intent query or scenario. By employing a tailored approach, the system effectively narrows down the search scope, thereby providing relevant results corresponding to multiple intents inherent in the user's query. A multi-use case query classifier determines whether each query is single intent or multi-intent and ascertains the intent behind each query. By effectively differentiating between these scenarios, the classifier ensures that the appropriate search methodology is utilized, resulting in a more efficient retrieval process and improved user satisfaction.

### BACKGROUND

Search retrieval systems can provide users with search results responsive to a variety of different types of queries. Some search retrieval systems use keywords in the input query to identify items in a catalogue or database of items which are responsive to the query. However, if the user enters a generic search query that lacks specific keywords, the system may be unable to provide search results desired by the user until the user inputs additional keywords or other more specific search terms to enable the system to identify the type of item or information which is responsive to the query. Other solutions may provide generic search results in response to generic search queries, which is unlikely to include the specific types of information desired by the user. This can be time-consuming, confusing, and potentially frustrating for users, as well as consuming excessive computing system resources, which can be costly and inefficient.

### SUMMARY

Some embodiments provide a system for query intent-aware search retrieval using generative artificial intelligence (AI) and vector similarity search. A search query is received. A classifier determines if the query is single intent or multi-intent. A multi-intent query encompasses multiple intents associated with a plurality of sub-categories associated with a category of the query. A query set of specific-intent queries corresponding to the plurality of sub-categories is generated. The query set is submitted to a search engine. Search results are obtained from the search engine. A multi-intent query results page is generated. The results page includes a plurality of types of items associated with the plurality of sub-categories organized into groups and/or a set of clickable tabs. The multi-intent query results page is presented to a user via a user interface (UI) device.

Other embodiments provide a method for query intent-aware search retrieval. A multi-intent query manager receives a generalized search query from a user device via a network, the generalized search query comprising a set of words corresponding to a category of item types. Multiple intents of the generalized search query are identified, the multiple intents associated with a plurality of sub-categories associated with the category. The multi-intent query manager generates a plurality of specific-intent queries corresponding to the plurality of sub-categories. The multi-intent query manager submits the plurality of specific-intent queries to a multi-query search engine. The multi-intent query manager obtains a plurality of results responsive to the plurality of specific-intent queries from the multi-query search engine, the plurality of results comprising a plurality of types of items associated with the plurality of sub-categories. The multi-intent query manager generates a multi-intent query results page comprising the plurality of results organized into a plurality of groups corresponding to each sub-category in the plurality of sub-categories. A plurality of clickable tabs are generated within the multi-intent query results page. The clickable tabs correspond to the identified multiple intents, each clickable tab corresponding to each group in the plurality of groups. The clickable tabs enable efficient presentation of multi-intent query results via the UI device. The multi-intent query manager presents the multi-intent query results page to a user via a user interface (UI) device.

Still other embodiments provide a computer storage devices having computer-executable instructions stored thereon, which, upon execution by a computer, cause the computer to obtain a generalized search query from a user device via a network, the generalized search query comprising a set of words corresponding to a category of item types. The generalized search query comprises multiple intents associated with a plurality of sub-categories associated with the category. A query set is generated that includes a plurality of specific-intent queries corresponding to the plurality of sub-categories. The query set is submitted to a multi-query search engine. Results are obtained from the multi-query search engine. The results include a plurality of types of items associated with the plurality of sub-categories. A results page is generated that includes clickable tabs linking to the plurality of results. Each clickable tab in the plurality of clickable tabs corresponds to a sub-category in the plurality of sub-categories. A user selects a clickable tab to view a set of results returned in response to a specific-intent query in the plurality of specific-intent queries. The results page is presented to the user via a UI device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for query intent-aware search retrieval with a unified results page having multiple intent-based result sub-categories.

FIG. 2 is an exemplary block diagram illustrating a system for query intent-aware search retrieval including a multi-intent query manager generating a query set for obtaining multi-intent search results responsive to the query.

FIG. 3 is an exemplary block diagram illustrating a system for multi-intent query responses using generative AI.

FIG. 4 is an exemplary block diagram illustrating a multi-intent query manager for classifying queries and generating customized specific-intent queries based on a single generalized search query.

FIG. 5 is an exemplary flow chart illustrating operation of the computing device to provide query intent-aware search retrieval results using generative artificial intelligence (AI) and vector similarity search.

FIG. 6 is an exemplary flow chart illustrating operation of the computing device to generate a results page including multi-intent query results.

FIG. 7 is an exemplary screenshot illustrating a multi-intent query results page.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Search retrieval systems can provide users with search results responsive to a variety of different types of queries. Some search retrieval systems use keywords in the input query to identify items in a catalogue or database of items which are responsive to the query. For example, if a user enters a query including the keywords “running” and “shoes,” the system returns items which can be described as running shoes or other athletic footwear. However, if the user enters a generic search term, such as “baby items,” the system may be unable to provide appropriate search results without requiring the user to input additional narrowing queries, such as “baby formula,” “baby clothes,” etc. In such cases, the user is required to provide a series of narrowing search terms until the system is able to identify a single type of item which is responsive to the query. Other solutions provide generic search results in response to generic search queries which are unlikely to provide the information desired by the user.

Currently, retailers define the specific use case related queries and create dynamic category pages which serve the wholistic requirements. Similarly, for a lot of multi-use case queries, search engines are defined with manually curated synonyms. To obtain relevant search results with a single query, retailers delineate particular use-case-oriented queries and formulate dynamic category pages, catering to the comprehensive necessities. Correspondingly, numerous multi-use-case queries necessitate search engines to be configured with manually curated synonyms to obtain accurate and contextually relevant results.

Referring to the figures, examples of the disclosure enable generative artificial intelligence (AI) and vector similarity search for multi-intent query search result retrieval. In some embodiments, the system incorporates generative AI methodologies in a search retrieval system to facilitate users in obtaining comprehensive and pertinent information with a single inquiry by comprehending the holistic intent underlying the member's query. The implementation of generative AI capabilities effectively addresses this issue by automating the understanding of user intent and generating appropriate responses, thereby streamlining the search process, and enhancing overall user experience. The system thereby reduces network bandwidth usage consumed by eliminating the need for users to enter multiple refining search queries or more multiple specific queries where the user desires multiple different types of items.

In other embodiments, the system provides a unified results page in which multiple sub-categories of results responsive to a user's multiple intent (multi-intent) generalized search query are presented in a single page. Sub-categories of results responsive to one or more of the intents inherent in the multi-intent query are presented in groups or sets of results within the results page for convenient viewing by the user, thereby improving user efficiency via the user interface (UI) and enabling increased user interaction performance.

Other embodiments provide a results page including a set of clickable tabs (buttons) corresponding to each type of item or sub-category of information responsive to the multi-intent query. A user clicks on one or more of the tabs to view items in that sub-category in the results page without the other sub-categories of results. This enables the user to focus quickly and easily on one or more sub-categories of results responsive to the initial generalized multi-intent query with improved efficiency. The results page UI is easily navigable enabling the user to display focused results for various sub-categories in a manner that reduces search time and potential confusion which might occur where multiple sub-categories of results are provided to the user.

The computing device operates in an unconventional manner by providing multiple sub-categories of results corresponding to a plurality of intents inherent in a generalized multi-intent search query without requiring additional narrowing search queries. In this manner, the computing device is used in an unconventional way, and allows reduced network bandwidth usage and reduced memory and processor usage consumed by fruitless search queries that fail to yield relevant results, thereby improving the functioning of the underlying computing device.

In other aspects, the system enables provision of multiple sub-categories of results responsive to a single multi-intent query that are more likely to be desired by the user. The multi-intent query search results are further displayed in the results page in an intuitive way for easy navigation via the UI. This reduces the number of unresponsive items returned to the user via the UI which are unresponsive to the multi-intent query, thereby reducing the error rate in query response generation and improving the user experience while reviewing search results via the results page.

Other embodiments include a customized profanity filter component which filters inappropriate queries. To maintain the integrity of the search retrieval system and prevent misuse by malicious actors, the customized profanity filter is implemented to perform a customized profanity check on each input query. This safeguard ensures that inappropriate or offensive language is effectively detected and mitigated, contributing to a secure and user-friendly experience.

In other embodiments, the system includes a multi-use case query classifier component which determines whether a query is single intent or multiple intent. The multi-use case query classifier accurately ascertains the intent behind a given query. This classifier determines whether a query encompasses multiple intents, necessitating the employment of the multi-intent query manager, or if it can be submitted directly to a traditional search engine for obtaining relevant recall. By effectively differentiating between these scenarios, the classifier ensures that the appropriate search methodology is utilized, resulting in a more efficient retrieval process and improved user satisfaction.

Still other aspects of the system enable customized prompt generator using AI capabilities to dynamically build a customized query set predicted to encompass multiple intents associated with a generalized input query scenario to help users by retrieving more accurate search results and curating the search recall page with all possible responsive item suggestions. This enables improved accuracy obtaining relevant information for the user based on predicted intents while reducing user time spent reviewing undesired information. The system further provides a better user search experience without the need for manually curated event-based category pages to fulfill user search requests in a faster manner.

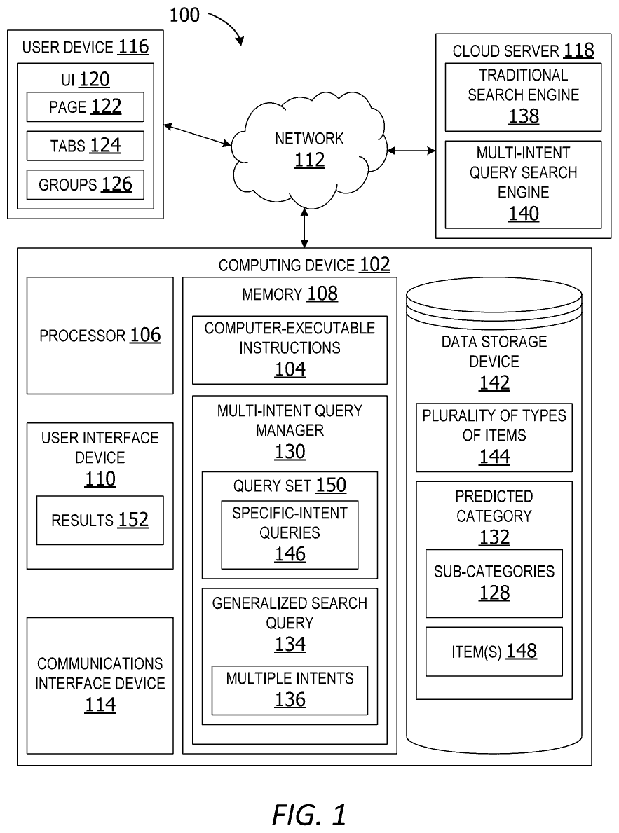

Referring again to FIG. 1, an exemplary block diagram illustrates a system 100 for query intent-aware search retrieval with a unified results page having multiple intent-based result sub-categories. In the example of FIG. 1, the computing device 102 represents any device executing computer-executable instructions 104 (e.g., as application programs, operating system functionality, or both) to implement the operations and functionality associated with the computing device 102. The computing device 102, in some embodiments includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some embodiments, the computing device 102 has at least one processor 106 and a memory 108. The computing device 102, in other examples includes a user interface device 110.

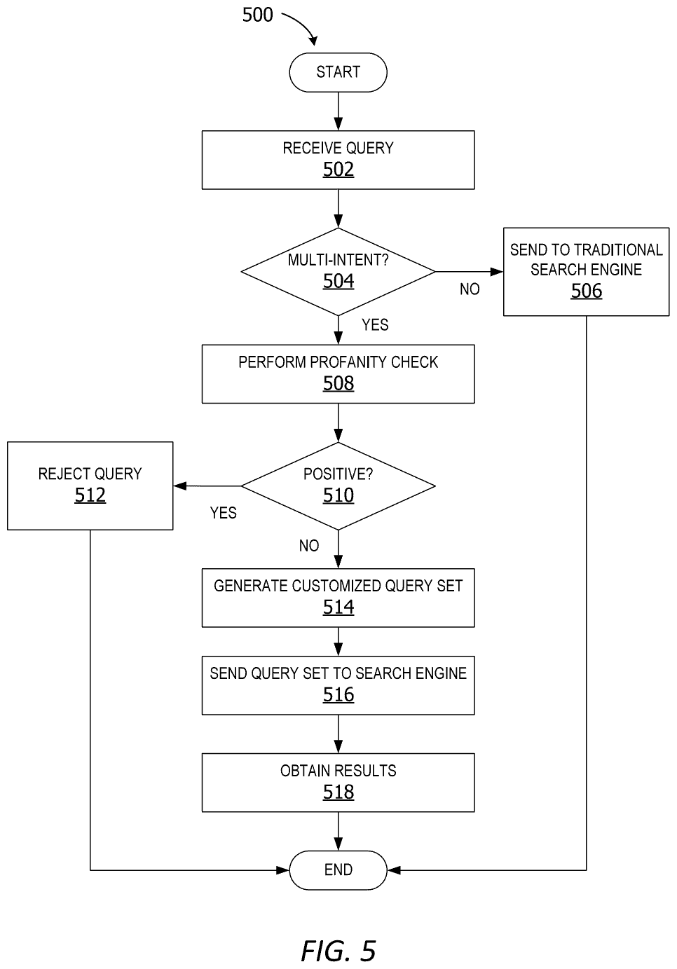

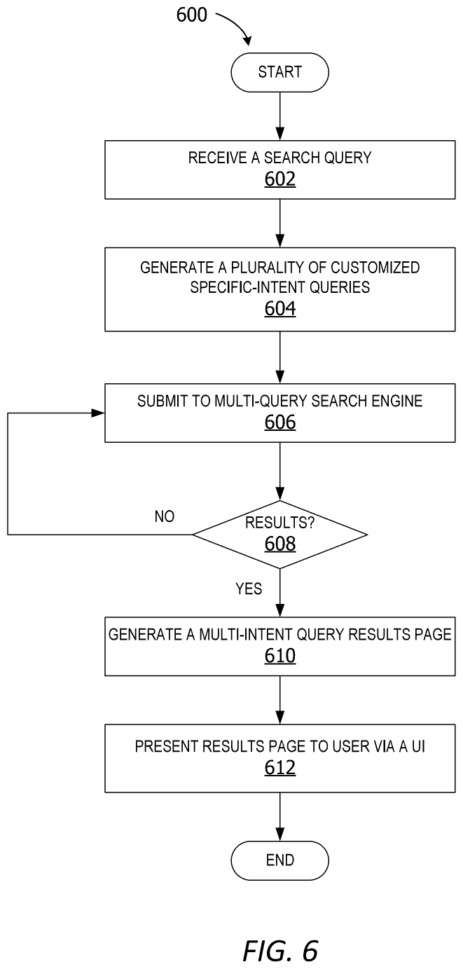

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some embodiments, the processor 106 is programmed to execute instructions such as those illustrated in the figures (e.g., FIG. 5 and FIG. 6).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other embodiments, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other embodiments, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some embodiments, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some embodiments, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device, such as, but not limited to, the UI 120.

In this example, the UI 120 displays data to a user, such as, but not limited to, a multi-intent query results page 122. The multi-intent query results page 122 includes a plurality of clickable tabs 124 and/or a plurality of groups 126 of results organized in accordance with a plurality of sub-categories 128 associated with a predicted category 132 of a generalized search query 134 having multiple intents 136. The predicted category is identified based on the generalized search query. In other words, the system generates a predicted category based on the words and/or phrases in the input generalized search query. The prediction is generated by the multi-intent query manager 130.

The generalized search query 134 is a search query which encompasses multiple use cases and/or intents. The multi-intent query manager 130 identifies the intents based on analysis of the words and/or phrases in the generalized search query. For example, a search query for “camping gear” is a generalized search query which can include multiple different types or sub-categories of results, such as, but not limited to, tents, canteens, sleeping bags, camp stoves, etc. In such cases, the generalized nature of the query suggests multiple different types of items which can be returned in response to the query by a multi-intent query manager 130.

The multi-intent query manager 130 is a software component including generative AI and vector similarity search to generate responses to a single generative search query 134 without requiring additional specific search queries to narrow the field of possible responses. Moreover, the multi-intent query manager 130 organizes the items returned in response to the generalized search query into groups 126 in the results page 122 for easy viewing and navigation by a user.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In this example, the cloud server 118 hosts a traditional search engine 138 for generating responses to single intent search queries. The cloud server 118 optionally also includes a multi-query search engine 140 for generating responses to multi-intent queries, such as, but not limited to, the generalized search query 134. However, the embodiments are not limited to implementing the traditional search engine 138 and/or the multi-query search engine 140 on the cloud server 118. In other embodiments, the traditional search engine 138 and/or the multi-query search engine 140 is implemented on the computing device 102.

The system 100 can optionally include a data storage device 142 for storing data, such as, but not limited to a plurality of types of items 144, predicted categories and sub-categories of items, specific-intent queries 146 stored in cache, and/or one or more item(s) 148 responsive to a query. The data storage device 142 can include one or more different types of data storage devices, such as, for example, one or more rotating disks drives, one or more solid state drives (SSDs), and/or any other type of data storage device. The data storage device 142 in some non-limiting examples includes a redundant array of independent disks (RAID) array. In some non-limiting embodiments, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 142 includes a database.

The data storage device 142 in this example is included within the computing device 102, attached to the computing device, plugged into the computing device, or otherwise associated with the computing device 102. In other examples, the data storage device 142 includes a remote data storage accessed by the computing device via the network 112, such as a remote data storage device, a data storage in a remote data center, or a cloud storage.

The memory 108 in some embodiments stores one or more computer-executable components, such as the multi-intent query manager 130, that, when executed by the processor 106 of the computing device 102, obtains the generalized search query 134 from the user device 116 via the network 112. In some embodiments, the multi-intent query manager 130 incudes a customized profanity filter, a query classifier to classify whether a query is a multi-intent (multi-use case) query, and/or a customized prompt generator for generating customized queries using generative AI capabilities.

The generalized search query 134 includes a set of one or more words corresponding to a predicted category 132 of item types. The generalized search query 134 includes multiple intents 136 associated with a plurality of search-related sub-categories 128 of the predicted category 132. For example, if the generalized search query 134 is a search for “party supplies,” the system generates a predicted category 132, such as the category of party supplies. The sub-categories include types of items such as, but not limited to, table clothes, party favors, balloons, streamers, cake, candles, etc.

In some embodiments, the multi-intent query manager generates a query set 150 including a plurality of customized specific-intent queries 146 corresponding to the plurality of search-related sub-categories 128. The specific-intent queries are customized to the multiple intents predicted based on the generalized search query. In the above example, the customized specific-intent queries for the party supplies category includes a query for table clothes, a query for birthday cake, a query for party balloons, etc.

In other embodiments, the multi-intent query manager 130 submits the query set, including the plurality of customized specific-intent queries 146, to the multi-query search engine 140 via the network 112. The multi-intent query manager 130 is a multi-query supported semantic search engine, in this example. The multi-query search engine 140 is implemented as a separate component from the multi-intent query manager 130 in this example. However, in other embodiments, the multi-query search engine is implemented as part of the multi-intent query manager 130.

In some embodiments, the multi-intent query manager 130 receives the results 152 that are responsive to the plurality of customized specific-intent queries 146 from the multi-query search engine 140. The specific-intent queries may be referred to as query suggestions.

The results 152 includes a plurality of types of items 144 associated with the plurality of search-related sub-categories 128. The multi-intent query manager 130 generates a multi-intent query results page 122 including the results 152 organized into a plurality of groups 126 corresponding to each sub-category in the plurality of sub-categories. In other embodiments, the results page includes a plurality of clickable tabs corresponding to the plurality of sub-categories. The multi-intent query results page 122 is presented to a user via a user interface (UI) device, such as, but not limited to, the user interface device 110 and/or the UI 120.

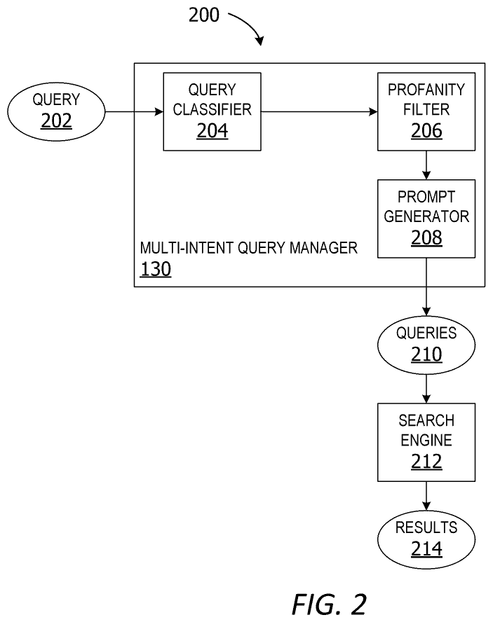

FIG. 2 is an exemplary block diagram illustrating a system 200 for query intent-aware search retrieval including a multi-intent query manager generating a query set for obtaining multi-intent search results responsive to the query. The multi-intent query manager 130 receives a query 202. A query classifier 204 classifies the query 202 as a single-intent query or a multi-intent query. A single-intent query is a query which is directed to a single type of item or type of information. For example, a search query for “toilet paper” is a single-intent query which specifically requests search results for items that can be described or identified as “toilet paper.” In another example, a search query for dog leashes is a specific query clearly identifying a single type of item desired by the user. However, if the search query request “dog supplies,” the query is generalized, multi-intent queries for which multiple different types of items could be desired by the user. The user may want to obtain search results including dog leashes, dog bowls, dog beds, dog collars, dog food, dog treats, etc.

In another example, if a generalized search query including the phrase “super bowl party” is received, the system identifies contextual query suggestions such as, but not limited to, chips, dip, wings, soda, hot dogs, hamburgers, tortilla chips, nachos, pretzels, etc. These query suggestions are used to generate a query set used to obtain results for a plurality of sub-categories which is presented to a user via a multi-intent query results page.

In another example, a multi-intent query for “men's clothes” is associated with contextual query suggestions, such as, but not limited to, men's shirts, men's pants, men's jeans, men's t-shirts, men's shorts, men's hoodies, men's active wear, etc. Likewise, a multi-intent query for “women's clothes” results in contextual query suggestions, such as, but not limited to, women's dresses, women's tops, women's pants, women's skirts, women's jackets, women's sweaters, etc.

A profanity filter 206 is applied to filter out any queries which include keywords or terms which are included in a set of prohibited words. The set of prohibited words is a user defined set of words, terms, and/or phrases. In one example, the profanity filter filters out queries related to illegal activities, such as kidnapping or burglary. In other example, the profanity filter filters out queries including profanity or inappropriate language.

In some embodiments, the profanity filter 206 operates in real-time to dynamically eliminate any inappropriate queries. In this example, the profanity filter 206 is applied after the query classifier classifies the query. However, in other embodiments, the query classifier is applied prior to classification of the query by the query classifier 204.

If the query 202 is not filtered by the profanity filter 206, a customized prompt generator 208 generates a plurality of queries 210 in a query set which encompasses the predicted sub-categories of the multi-intent query. The query set including the queries 210 is submitted to a search engine 212. The search engine 212 returns results 214 for presentation to a user via a results page on a UI. The search engine 212 is a search engine, such as, but not limited to, the multi-intent query manager 130.

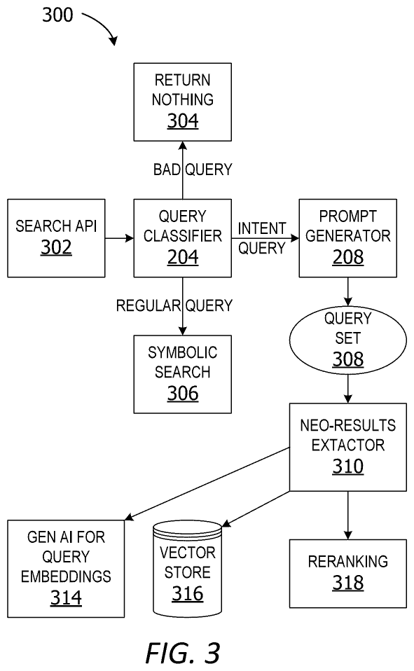

Turning now to FIG. 3, an exemplary block diagram illustrating a system 300 for multi-intent query responses using generative AI is shown. In some embodiments, the query classifier 204 receives a query from a search application programming interface (API) 302 associated with a user device, such as, but not limited to, the user device 116 in FIG. 1.

If the query is a bad query, the query classifier returns nothing 304. A bad query is a query having incorrect syntax, filtered out by the profanity filter, or other issues which renders the query unsuitable for processing. If the query is a single-intent query, the query is handled by a traditional search engine, such as via a symbolic search 306. If the query is a multi-intent query, the query is sent to a customized prompt generator 208. The prompt generator 208 generates a query set 308 including multiple specific-intent queries. The query set 308, in this example, is received by a neo-results extractor 310 which extracts keywords for use by a generative AI for query embeddings 314 hosted on a cloud platform for generating embeddings of each query. The embeddings are generated by a machine learning (ML), deep learning embedding model. The embeddings are used to generate vectors representing each word or set of words in each query and/or candidate search results. The vectors are optionally stored in a vector store 316, such as a database or cache. The search results obtained based on semantic similarity of the candidate items to the search query terms are ranked and/or re-ranked during a reranking 318 to identify the top results to return to the user. The top results include the item or items which have the greatest or closest semantic similarity with the query.

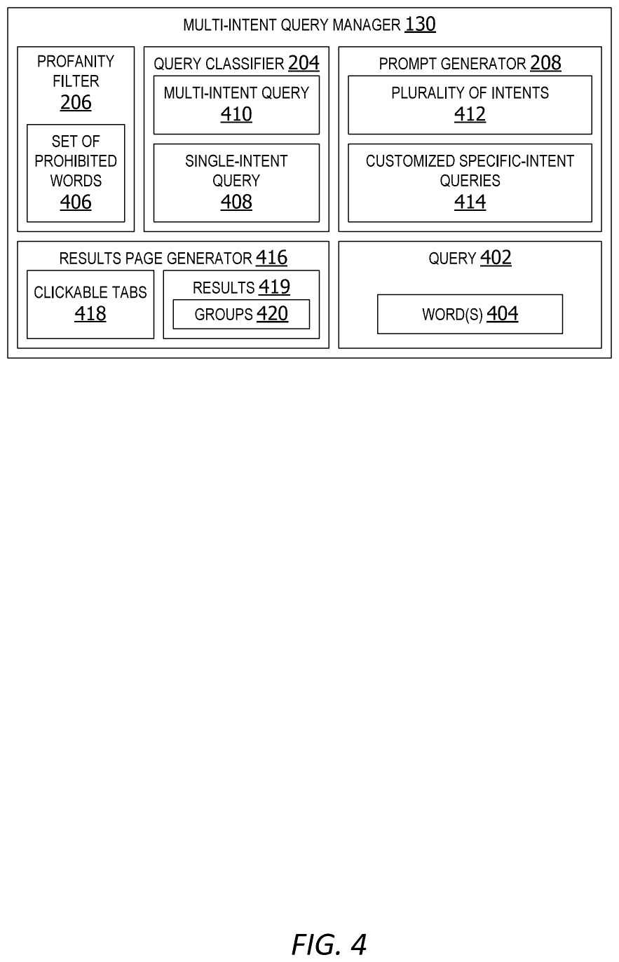

FIG. 4 is an exemplary block diagram illustrating a multi-intent query manager 130 for classifying queries and generating specific-intent queries based on a single generalized search query. The multi-intent query manager 130 in some embodiments receives a query 402 including a set of one or more word(s) 404. A profanity filter 206 compares the word(s) 404 in the query 402 with one or more words or phrases in a set of prohibited words 406. If the query 402 includes one or more of the prohibited words in the set of prohibited words 406, the query 402 is filtered out and no response to the query is generated.

If the query is not filtered out by the profanity filter 206, a query classifier 204 analyzes the query 402 to determine whether the query is a single-intent query 408 or a multi-intent query 410. If the query 402 is a single-intent query 408, the query is sent to a traditional search query engine. If the query classifier 204 classifies the query 402 as a multi-intent query 410, a customized prompt generator 208 identifies a plurality of intents 412 associated with the query 402. The customized prompt generator 208 generates a plurality of customized specific-intent queries 414 corresponding to the plurality of intents 412. The customized specific-intent queries 414 are submitted to a search engine, such as, but not limited to, the multi-query search engine 140. The results 419 responsive to the customized specific-intent queries 414 are received from the search engine.

In some embodiments, a results page generator 416 generates a results page containing a plurality of clickable tabs 418 and/or the results 419 presented in groups 420 in accordance with the sub-categories of types of items returned in the results 419. A user clicks on a tab in the clickable tabs to view all results returned for a specific sub-category of types of items.

FIG. 5 is an exemplary flow chart illustrating operation of the computing device to provide query intent-aware search retrieval results using generative artificial intelligence (AI) and vector similarity search. The process 500 shown in FIG. 5 is performed by a multi-intent query manager component, executing on a computing device, such as the computing device 102 or the user device 116 in FIG. 1.

The process begins by receiving a query at 502. In this example, the query is a general search query, such as, but not limited to, the generalized search query 134 in FIG. 1. A determination is made whether the query is a multi-intent query at 504. If not, the multi-intent query manager sends the query to a traditional search engine at 506. The process terminates thereafter.

If the query is a multi-intent query at 504, the multi-intent query manager performs a profanity check at 508. A determination is made whether the profanity check is positive at 510. A positive profanity check indicates one or more words or phrases in the query are included in a list of prohibited words or phrases. If the profanity check is positive, the query is rejected at 512. The process terminates thereafter.

If the profanity check is negative at 510, a customize query set is generated at 514. The customized query set includes a plurality of specific-intent queries, such as the specific-intent queries 146 in FIG. 1. The query set is sent to a search engine at 516. The search engine is capable of handling multiple specific-intent queries, such as, but not limited to, the multi-query search engine 140 in FIG. 1 and/or the search engine 212 in FIG. 2. The results of the query search performed using the query set are obtained from the search engine at 518. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

Turning now to FIG. 6, an exemplary flow chart illustrating operation of the computing device to generate a results page including multi-intent query results is shown. The process 600 shown in FIG. 6 is performed by a multi-intent query manager component, executing on a computing device, such as the computing device 102 or the user device 116 in FIG. 1.

The process begins by receiving a search query at 602. The multi-intent query manager generates a plurality of customized specific-intent queries based on the single search query at 604. The customized specific-intent queries are generated by a customized prompt generator, such as, but not limited to, the prompt generator 208 in FIG. 2, FIG. 3 and/or FIG. 4. The multi-intent query manager submits the customized specific-intent queries to a multi-query search engine at 606. A determination is made whether results of the customized specific-intent queries are received at 608. If not, the process waits until results are received at 608. The multi-intent query manager generates a multi-intent query results page at 610. The results page is presented to a user via a UI at 612. The UI is a user interface device, such as, but not limited to, the user interface device 110 and/or the UI 120 in FIG. 1. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

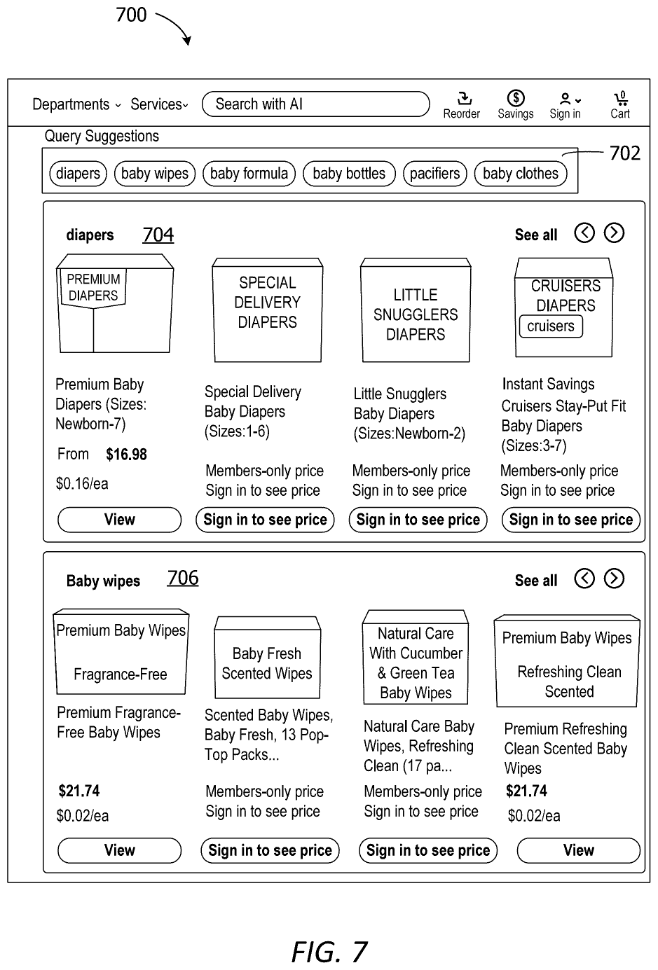

FIG. 7 is an exemplary screenshot illustrating a multi-intent query results page 700. In some embodiments, the multi-intent query results page 700 includes a set of clickable tabs 702. A user selects a tab to view results for the sub-category of items linked to the tab. For example, if the user selects the tab for diapers, the results page 700 displays only results for diapers. Likewise, in this example, if the user clicks on the tab for baby formula, the results page 700 updates to present only baby formula items to the user.

In this example, the results of the multi-intent search are arranged in groups in accordance with the type of item. In this example, a sample or set of diaper items are presented in a first group 704, a sample or set of baby wipes are presented in the second group 706. A sample of items for each sub-category are presented in a separate group for quick and easy viewing by the user. The user selects a tab to view additional instances of search results for a given sub-category without the distraction of other groups of items associated with other undesired sub-categories of items.

### Additional Examples

Some embodiments provide a query intent-aware search retrieval system using generative artificial intelligence (AI) and vector similarity search to provide specific-intent results corresponding to multiple predicted sub-categories of items desired by a user submitting the search query without providing additional narrowing search terms. A customized profanity filter performs a customized profanity check to maintain the integrity of the search retrieval system and prevent misuse by malicious actors. This safeguard ensures that inappropriate or offensive language is effectively detected and mitigated, contributing to a secure and user-friendly experience. A customized prompt generator enables the generation of pertinent recall queries for a specific intent query or scenario. By employing a tailored approach, the system effectively narrows down the search scope, thereby providing relevant results corresponding to the user's query. A multi-use case query classifier accurately ascertains the intent behind each query. This classifier determines whether a query encompasses multiple intents, necessitating the employment of a novel approach, or if it can be submitted directly to a traditional search engine for obtaining relevant recall. By effectively differentiating between these scenarios, the classifier ensures that the appropriate search methodology is utilized, resulting in a more efficient retrieval process and improved user satisfaction.

In some embodiments, the system uses generative AI methodologies in a search retrieval system to provide comprehensive and pertinent information to a user in response to an input inquiry by comprehending the holistic intent underlying the query. The system identifies multiple user intent inherent in the query and generates appropriate responses, thereby streamlining the search process and enhancing overall user experience.

The system captures the intent of each user query and provides overall required products (item and/or information) suggestions. In some embodiments, the system extracts details, such as keywords, from a generalized search query using a large language model (LLM). The system combines the extracted details with vector based search to provide more accurate search results with improved recall.

In an example scenario, a user inputs a generalized search query for Thanksgiving supplies. The system analyzes this query and determines it is a multi-intent query for which the user desires search results encompassing a variety of different types of items. In response to this query, the system generates a query set of customized specific-intent queries for sub-categories of items related to the category of Thanksgiving supplies, such as turkey, stuffing, gravy, cranberry sauce, green beans, etc. The results are presented via a results page having a clickable tab for each sub-category of results. A user selects a tab for cranberry sauce to view all the cranberry sauce items. The user selects a tab labeled stuffing to view items associated with turkey stuffing.

In other embodiments, the system uses the customized prompt-based generative AI capabilities to dynamically build the query set for a scenario to help members in curate the search recall page with all possible required product suggestions. The system includes customized profanity checker module, a classifier to classify if a user query is multi-use case query, a customized prompt generation for generative AI capabilities, and multi-query supported semantic search engine. This enables a better user search experience via the user interface with more rapid and accurate results produced. There is no need to manually curate event-based category pages. Moreover, the system is able to fulfill member requirements in a faster and more efficient manner while reducing system resource usage and time consumed on searches.

For example, the multi-intent query searches enable users to obtain desired search results with a single search query rather than having to provide multiple search queries while gradually refining the search and narrowing down the search results. This reduces system processor usage, memory usage, and network bandwidth usage for an improved system performance.

In other embodiments, the system enables a combination of prompts for contextual query suggestions with few shot learning based approach to provide better quality contextual suggestions. The intent and profanity check with few shot learning based approach provides better coverage and scenarios for profanity check.

In an example, a user enters a query. A classifier determines if the query is a multi-use case query. If not, the query is handled by an indexed search engine. If the query is multi-use case, a profanity checker component is applied to determine if the query triggers any, profanity alerts/flags. If yes, the query is rejected. If not, a customized prompt is generated, A generative AI system determines relevant queries. A multi-query supported semantic search engine generates a query recall which provides search results responsive to the original user query without requiring the user to provide any additional search query terms or additional search requests to obtain the intended results.

In an example scenario, a user entering a search query for baby-related items or baby supplies might receive back search results for baby diapers, baby wipes, baby formula, baby bottles, baby pacifiers, baby clothes, etc. Each group or sub-group of items are presented to the user with a tab or category heading subdividing the search results. A user can select the tab for the desired items, such as selecting the tab baby diapers if the user wants to purchase diapers. A user can select multiple tabs for selecting items from multiple sub-categories without providing additional search terms, as the single search query for “baby items” returns results for multiple baby-related groups or sub-groups (categories) of items in a single search result.

In some embodiments, the multi-intent or multi-user search results are returned with both category/group headings (tabs) as well as a sampling of top search results for each category displayed on the user interface search results display page provided by the system. The top search results are results predicted to be of greatest interest to the user. The user views the results and selects or clicks on category tabs or individual items to obtain additional information regarding the selected category/item clicked on. In this manner the user can easily view a variety of different search results on a single page at one time without entering multiple different search queries to gradually refine the initial search down to desired items, such as diapers and/or baby clothes. This provides faster and more efficient results with improved performance via the user interface while further improving user efficiency and enhancing customer goodwill.

In another embodiment, the system implements generative AI and vector similarity methodologies in a search retrieval system that provides comprehensive responsive information to a user in response to the search query. The system implements a customized prompt generator for generating pertinent recall queries for a specific intent query. The system implements a tailored approach to effectively narrow down the search scope and provide relevant results corresponding to the query. The system implements a customized profanity filter to ensure that inappropriate language is effectively detected and mitigated. The system implements a multi-use case query classifier to ascertain the intent behind each query. The classifier determines whether each query encompasses multiple intents. The classifier ensures the appropriate utilization of search methodology by effectively differentiating between the intents.

In other embodiments, queries and results of queries are stored in cache. When a new query is received and/or results of a query are being generated, the system searches the cache for the query and/or results of the query. If the query or results of the query are cached, the system retrieves the query and/or results related information from the cache for use in responding to the queries and/or generating the results page. The plurality of clickable tabs enabling efficient presentation of all multi-intent query results via the UI device rather than merely a sampling or subset of the query results.

Alternatively, or in addition to the other examples described herein, examples include any combination of the following:
receive a plurality of generalized search queries;
filter a set of generalized search queries from the plurality of generalized search queries having at least one word in a set of prohibited words;
receive a plurality of generalized search queries;
identify a set of single-intent queries in the plurality of generalized search queries having a single intent;
identify a set of multi-intent queries in the plurality of generalized search queries;
send the set of single-intent queries to a traditional search engine;
send the set of multiple-intent queries to the multi-intent query search engine;
analyze the generalize search query by a multi-use case query classifier;
determine whether the generalized search query is a multi-intent query or a single-intent query;
send the generalized search query to a traditional search engine responsive to a determination the generalized search query is the single-intent query;
send the generalized search query to a customized prompt generator responsive to the determination the generalized search query is the multi-intent query;
generate a plurality of clickable tabs within the multi-intent query results page corresponding to each group in the plurality of groups, wherein the user selects a clickable tab associated with a sub-category of types of items in the plurality of results to view a selected type of item in a sub-category results page;
generate a first customized specific-intent query corresponding to a first predicted intent associated with the generalized search query;
generate a second customized specific-intent query corresponding to a second predicted intent associated with the generalized search query;
send the first customized specific-intent query and the second customized specific-intent query to the multi-query search engine;
receive a first set of results responsive to the first customized specific-intent query from the multi-query search engine;
receive a second set of results responsive to the second customized specific-intent query from the multi-query search engine;
generate a first clickable tab in a plurality of clickable tabs in the multi-intent query results page;
generate a second clickable tab in the plurality of clickable tabs in the multi-intent query results page, wherein the user selects the first clickable tab to view the first set of results, and wherein the user selects the second clickable tab to view the second set of results;
receiving a generalized search query from a user device via a network, the generalized search query comprising a set of words corresponding to a predicted category of item types, wherein the generalized search query comprises multiple intents associated with a plurality of search-related sub-categories associated with the predicted category;
generating a plurality of customized specific-intent queries corresponding to the plurality of search-related sub-categories;
submitting the plurality of customized specific-intent queries to a multi-query search engine;
obtaining a plurality of results responsive to the plurality of customized specific-intent queries from the multi-query search engine, the plurality of results comprising a plurality of types of items associated with the plurality of search-related sub-categories;
generating a multi-intent query results page comprising the plurality of results organized into a plurality of groups corresponding to each sub-category in the plurality of sub-categories;
presenting the multi-intent query results page to a user via a user interface (UI) device;
receiving a plurality of generalized search queries;
filtering a set of generalized search queries from the plurality of generalized search queries having at least one word in a set of prohibited words;
receiving a plurality of generalized search queries;
identifying a set of single-intent queries in the plurality of generalized search queries having a single intent;
identifying a set of multi-intent queries in the plurality of generalized search queries;
sending the set of single-intent queries to a traditional search engine;
sending the set of multiple-intent queries to the multi-intent query search engine;
analyzing the generalize search query by a multi-use case query classifier;
determining whether the generalized search query is a multi-intent query or a single-intent query;
routing the generalized search query to a traditional search engine responsive to a determination the generalized search query is the single-intent query;
routing the generalized search query to a customized prompt generator responsive to the determination the generalized search query is the multi-intent query;
generating a plurality of clickable tabs within the multi-intent query results page corresponding to each group in the plurality of groups, wherein the user selects a clickable tab associated with a sub-category of types of items in the plurality of results to view a selected type of item in a sub-category results page;
generating a first customized specific-intent query corresponding to a first predicted intent associated with the generalized search query;
generating a second customized specific-intent query corresponding to a second predicted intent associated with the generalized search query;
sending the first customized specific-intent query and the second customized specific-intent query to the multi-query search engine;
receiving a first set of results responsive to the first customized specific-intent query from the multi-query search engine;
receiving a second set of results responsive to the second customized specific-intent query from the multi-query search engine;
generating a first clickable tab in a plurality of clickable tabs in the multi-intent query results page;
generating a second clickable tab in the plurality of clickable tabs in the multi-intent query results page, wherein the user selects the first clickable tab to view the first set of results, and wherein the user selects the second clickable tab to view the second set of results;
obtaining a generalized search query from a user device via a network, the generalized search query comprising a set of words corresponding to a predicted category of item types, wherein the generalized search query comprises multiple intents associated with a plurality of search-related sub-categories associated with the predicted category;
generating a plurality of customized specific-intent queries corresponding to the plurality of search-related sub-categories;
submitting the plurality of customized specific-intent queries to a multi-query search engine;
obtaining a plurality of results responsive to the plurality of customized specific-intent queries from the multi-query search engine, the plurality of results comprising a plurality of types of items associated with the plurality of search-related sub-categories;
generating a multi-intent query results page comprising a plurality of clickable tabs linking to the plurality of results, wherein each clickable tab in the plurality of clickable tabs corresponds to a sub-category in the plurality of sub-categories, and wherein a user selects a clickable tab in the plurality of clickable tabs to view a set of results returned in response to a customized specific-intent query in the plurality of customized specific-intent queries;
presenting the multi-intent query results page to a user via a user interface (UI) device;
presenting a plurality of types of items associated with the plurality of search-related sub-categories in the plurality of results on the multi-intent query results page, the plurality of types of items organized into a plurality of groups corresponding to each sub-category in the plurality of sub-categories;
applying a customized profanity filter to a first generalized search query and a second generalized search query;
filtering the first generalized search query responsive to detection of at least one word in a set of prohibited words within the first generalized search query;
generating a query set comprising customized specific-intent queries responsive to a failure to detect at least one word in the set of prohibited words within the second generalized search query;
classifying a first set of generalized search queries as single-intent queries for handling by a traditional search engine;
classifying a second set of generalized search queries as multi-intent queries, wherein the second set of generalized search queries are handled by a multi-intent query search engine;
differentiating between single-intent generalized search queries and multi-intent generalized search queries;
generating a first customized specific-intent query corresponding to a first predicted intent associated with the generalized search query; and
generating a second customized specific-intent query corresponding to a second predicted intent associated with the generalized search query, wherein the first customized specific-intent query and the second customized specific-intent query are sent to the multi-query search engine.

At least a portion of the functionality of the various elements in FIG. 1, FIG. 2, FIG. 3, and FIG. 4 can be performed by other elements in FIG. 1, FIG. 2, FIG. 3, and FIG. 4, or an entity (e.g., processor 106, web service, server, application program, computing device, etc.) not shown in FIG. 1, FIG. 2, FIG. 3, and FIG. 4.

In some embodiments, the operations illustrated in FIG. 5 and FIG. 6 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other embodiments, a computer readable medium having instructions recorded thereon which when executed by a computer device cause the computer device to cooperate in performing a method of query intent-aware search retrieval, the method comprising receiving a generalized search query from a user device via a network, the generalized search query comprising a set of words corresponding to a predicted category of item types, wherein the generalized search query comprises multiple intents associated with a plurality of search-related sub-categories associated with the predicted category; performing a profanity check; classifying the query as a multi-intent query; generating a plurality of customized specific-intent queries corresponding to the plurality of search-related sub-categories; submitting the plurality of customized specific-intent queries to a multi-query search engine; obtaining a plurality of results responsive to the plurality of customized specific-intent queries from the multi-query search engine, the plurality of results comprising a plurality of types of items associated with the plurality of search-related sub-categories; generating a multi-intent query results page comprising the plurality of results organized into a plurality of groups corresponding to each sub-category in the plurality of sub-categories; and presenting the multi-intent query results page to a user via a user interface (UI) device.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for query intent-aware search retrieval. For example, the elements illustrated in FIG. 1, FIG. 2, FIG. 3, and FIG. 4, such as when encoded to perform the operations illustrated in FIG. 5 and FIG. 6, constitute exemplary means for receiving a generalized search query from a user device via a network, the generalized search query comprising a set of words corresponding to a predicted category of item types, wherein the generalized search query comprises multiple intents associated with a plurality of search-related sub-categories associated with the predicted category; exemplary means for performing a customized profanity check; exemplary means for classifying the query as a multi-intent query; exemplary means for generating a plurality of customized specific-intent queries corresponding to the plurality of search-related sub-categories; exemplary means for submitting the plurality of customized specific-intent queries to a multi-query search engine; exemplary means for obtaining a plurality of results responsive to the plurality of customized specific-intent queries from the multi-query search engine, the plurality of results comprising a plurality of types of items associated with the plurality of search-related sub-categories; exemplary means for generating a multi-intent query results page comprising the plurality of results organized into a plurality of groups corresponding to each sub-category in the plurality of sub-categories; and exemplary means for presenting the multi-intent query results page to a user via a user interface (UI) device.

Other non-limiting embodiments provide one or more computer storage devices having a first computer-executable instructions stored thereon for providing query intent-aware search retrieval results. When executed by a computer, the computer performs operations including obtaining a generalized search query from a user device via a network, the generalized search query comprising a set of words corresponding to a predicted category of item types, wherein the generalized search query comprises multiple intents associated with a plurality of search-related sub-categories associated with the predicted category; applying a customized profanity filter; classifying the query as a single-intent query or a multi-intent query; generating a plurality of customized specific-intent queries corresponding to the plurality of search-related sub-categories; submitting the plurality of customized specific-intent queries to a multi-query search engine; obtaining a plurality of results responsive to the plurality of customized specific-intent queries from the multi-query search engine, the plurality of results comprising a plurality of types of items associated with the plurality of sub-categories; generating a multi-intent query results page comprising a plurality of clickable tabs linking to the plurality of results, wherein each clickable tab in the plurality of clickable tabs corresponds to a sub-category in the plurality of sub-categories, and wherein a user selects a clickable tab in the plurality of clickable tabs to view a set of results returned in response to a customized specific-intent query in the plurality of customized specific-intent queries; and presenting the multi-intent query results page to a user via a user interface (UI) device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system for query intent-aware search retrieval, the system comprising:
a processor; and
a computer-readable medium storing instructions that are operative upon execution by the processor to:
obtain a generalized search query from a user device via a network, the generalized search query comprising a set of words corresponding to a category of item types;
identify multiple intents associated with a plurality of sub-categories associated with the category;
generate a plurality of specific-intent queries corresponding to the plurality of sub-categories;
submit the plurality of specific-intent queries to a multi-query search engine;
obtain a plurality of results responsive to the plurality of specific-intent queries from the multi-query search engine, the plurality of results comprising a plurality of types of items associated with the plurality of sub-categories;
generate a multi-intent query results page comprising grouped multi-intent query results, the grouped multi-intent query results comprising the plurality of results organized into a plurality of groups corresponding to each sub-category in the plurality of sub-categories, wherein the multi-intent query results page is presented to a user via a user interface (UI) device; and
create a plurality of clickable tabs within the multi-intent query results page corresponding to identified multiple intents, each clickable tab linked to a group in the plurality of groups, the plurality of clickable tabs enabling non-linear navigation and real-time presentation of the grouped multi-intent query results via the UI device.

2. The system of claim 1, wherein the instructions are further operative to:
receive a plurality of generalized search queries; and
filter a set of generalized search queries from the plurality of generalized search queries having at least one word in a set of prohibited words.

3. The system of claim 1, wherein the instructions are further operative to:
receive a plurality of generalized search queries;
identify a set of single-intent queries in the plurality of generalized search queries having a single intent;
identify a set of multi-intent queries in the plurality of generalized search queries;
send the set of single-intent queries to a traditional search engine; and
send the set of multi-intent queries to the multi-query search engine.

4. The system of claim 1, wherein the instructions are further operative to:
analyze the generalized search query by a multi-use case query classifier;
determine whether the generalized search query is a multi-intent query or a single-intent query;
send the generalized search query to a traditional search engine responsive to a determination the generalized search query is the single-intent query; and
send the generalized search query to a customized prompt generator responsive to the determination the generalized search query is the multi-intent query.

5. The system of claim 1, wherein the instructions are further operative to:
link each clickable tab in the plurality of clickable tabs to a set of query results, wherein each clickable tab is associated with a sub-category of types of items in the plurality of results.

6. The system of claim 1, wherein the instructions are further operative to:
generate a first customized specific-intent query corresponding to a first predicted intent associated with the generalized search query;
generate a second customized specific-intent query corresponding to a second predicted intent associated with the generalized search query; and
send the first customized specific-intent query and the second customized specific-intent query to the multi-query search engine.

7. The system of claim 6, wherein the instructions are further operative to:
receive a first set of results responsive to the first customized specific-intent query from the multi-query search engine;
receive a second set of results responsive to the second customized specific-intent query from the multi-query search engine;
generate a first clickable tab in a plurality of clickable tabs in the multi-intent query results page; and
generate a second clickable tab in the plurality of clickable tabs in the multi-intent query results page, wherein the user selects the first clickable tab to view the first set of results, and wherein the user selects the second clickable tab to view the second set of results.

8. A method for query intent-aware search retrieval, the method comprising:
receiving a generalized search query from a user device via a network, the generalized search query comprising a set of words corresponding to a category of item types, wherein the generalized search query comprises multiple intents associated with a plurality of sub-categories associated with the category;
generating a plurality of specific-intent queries corresponding to the plurality of sub-categories;
submitting the plurality of specific-intent queries to a multi-query search engine;
obtaining a plurality of results responsive to the plurality of specific-intent queries from the multi-query search engine, the plurality of results comprising a plurality of types of items associated with the plurality of sub-categories;
generating a multi-intent query results page comprising grouped multi-intent query results, the grouped multi-intent query results comprising the plurality of results organized into a plurality of groups corresponding to each sub-category in the plurality of sub-categories;
generating a plurality of clickable tabs within the multi-intent query results page corresponding to identified multiple intents, each clickable tab linked to a group in the plurality of groups; and
presenting the multi-intent query results page to a user via a user interface (UI) device, the plurality of clickable tabs enabling presentation of the grouped multi-intent query results via the UI device.

9. The method of claim 8, further comprising:
receiving a plurality of generalized search queries; and
filtering a set of generalized search queries from the plurality of generalized search queries having at least one word in a set of prohibited words.

10. The method of claim 8, further comprising:
receiving a plurality of generalized search queries;
identifying a set of single-intent queries in the plurality of generalized search queries having a single intent;
identifying a set of multi-intent queries in the plurality of generalized search queries;
sending the set of single-intent queries to a traditional search engine; and
sending the set of multi-intent queries to the multi-query search engine.

11. The method of claim 8, further comprising:
analyzing the generalized search query by a multi-use case query classifier;
determining whether the generalized search query is a multi-intent query or a single-intent query;
routing the generalized search query to a traditional search engine responsive to a determination the generalized search query is the single-intent query; and
routing the generalized search query to a customized prompt generator responsive to the determination the generalized search query is the multi-intent query.

12. The method of claim 8, further comprising:
generating a plurality of clickable tabs within the multi-intent query results page corresponding to each group in the plurality of groups, wherein the user selects a clickable tab associated with a sub-category of types of items in the plurality of results to view a selected type of item in a sub-category results page.

13. The method of claim 8, further comprising:
generating a first customized specific-intent query corresponding to a first predicted intent associated with the generalized search query;
generating a second customized specific-intent query corresponding to a second predicted intent associated with the generalized search query; and
sending the first customized specific-intent query and the second customized specific-intent query to the multi-query search engine.

14. The method of claim 8, further comprising:
receiving a first set of results responsive to a first customized specific-intent query from the multi-query search engine;
receiving a second set of results responsive to a second customized specific-intent query from the multi-query search engine;
generating a first clickable tab in a plurality of clickable tabs in the multi-intent query results page; and
generating a second clickable tab in the plurality of clickable tabs in the multi-intent query results page, wherein the user selects the first clickable tab to view the first set of results, and wherein the user selects the second clickable tab to view the second set of results.

15. One or more computer storage devices having computer-executable instructions stored thereon, which, upon execution by a computer, cause the computer to perform operations comprising:
obtaining a generalized search query from a user device via a network, the generalized search query comprising a set of words corresponding to a category of item types, wherein the generalized search query comprises multiple intents associated with a plurality of sub-categories associated with the category of item types;
generating a query set comprising a plurality of specific-intent queries corresponding to the plurality of sub-categories;
submitting the query set to a multi-query search engine;
obtaining a plurality of results responsive to the plurality of specific-intent queries from the multi-query search engine, the plurality of results comprising a plurality of types of items associated with the plurality of sub-categories;
generating a multi-intent query results page comprising grouped multi-intent query results and a plurality of clickable tabs linking to the plurality of results, wherein each clickable tab linked to a group in the plurality of clickable tabs corresponds to a sub-category in the plurality of sub-categories, and wherein a user selects a clickable tab in the plurality of clickable tabs to view a set of results returned in response to a specific-intent query in the plurality of specific-intent queries; and
presenting the multi-intent query results page to the user via a user interface (UI) device, the plurality of clickable tabs enabling non-linear navigation and real-time presentation of the grouped multi-intent query results via the UI device.

16. The one or more computer storage devices of claim 15, wherein the operations further comprise:
presenting a plurality of types of items associated with the plurality of sub-categories in the plurality of results on the multi-intent query results page, the plurality of types of items organized into a plurality of groups corresponding to each sub-category in the plurality of sub-categories.

17. The one or more computer storage devices of claim 15, wherein the operations further comprise:
applying a customized profanity filter to a first generalized search query and a second generalized search query;
filtering the first generalized search query responsive to detection of at least one word in a set of prohibited words within the first generalized search query; and
generating a query set comprising customized specific-intent queries responsive to a failure to detect at least one word in the set of prohibited words within the second generalized search query.

18. The one or more computer storage devices of claim 15, wherein the operations further comprise:
classifying a first set of generalized search queries as single-intent queries for handling by a traditional search engine; and
classifying a second set of generalized search queries as multi-intent queries, wherein the second set of generalized search queries are handled by a multi-intent query search engine.

19. The one or more computer storage devices of claim 15, wherein the operations further comprise:
differentiating between single-intent generalized search queries and multi-intent generalized search queries.

20. The one or more computer storage devices of claim 15, wherein the operations further comprise:
generating a first customized specific-intent query corresponding to a first predicted intent associated with the generalized search query; and
generating a second customized specific-intent query corresponding to a second predicted intent associated with the generalized search query, wherein the first customized specific-intent query and the second customized specific-intent query are sent to the multi-query search engine.
